(19) United States
(12) Patent Application Publication
(10) Pub. No.: US 2025/0304864 A1
(43) Pub. Date: Oct. 2, 2025

(54) Method For Processing Heavy Petroleum Feedstock

(71) Applicant: TAIF Joint-Stock Company, Kazan (RU)

(72) Inventors: Albert Kashafovich Shigabutdinov, Kazan (RU); Vladimir Vasilievich PRESNYAKOV, Kazan (RU); Ruslan Albertovich SHIGABUTDINOV, Kazan (RU); Rustem Nazyifovich AKHUNOV, Kazan (RU); Marat Rinatovich IDRISOV, Kazan (RU); Maksim Anatolievich NOVIKOV, Nizhnekamsk (RU); Aleksei Aleksandrovich KHRAMOV, Nizhnekamsk (RU); Andrei Aleksandrovich KONOVNIN, Nizhnekamsk (RU); Artur Semenovich URAZAIKIN, Nizhnekamsk (RU); Viswanathan Anand SUBRAMANIAN, Sugar Land, TX (US)

(21) Appl. No.: 18/618,056

(22) Filed: Mar. 27, 2024

(51) Int. Cl. C10G 67/14; B01J 20/20; B01J 20/28; C10G 7/06; C10G 65/10; C10G 69/14; C10L 5/04

(52) U.S. Cl. CPC C10G 67/14; B01J 20/20; B01J 20/28004; B01J 20/28061; B01J 20/28071; C10G 7/06; C10G 65/10; C10G 69/14; C10L 5/04; C10G 2300/301; C10G 2300/308; C10G 2300/4081; C10G 2300/44; C10G 2400/16

(57) ABSTRACT

The invention relates to the field of petroleum processing, in particular to processes allowing the production of valuable products from heavy residues. A method for processing heavy petroleum feedstock is proposed, the method comprising hydrocracking a feedstock in a slurry phase (SPH) followed by separation into a stream of an SPH-subjected feedstock and a heavy residue stream, wherein the heavy residue stream is a slurry of an unconverted high-boiling residue and an exhausted coal additive; hydrocracking the SPH-subjected feedstock in gas phase, followed by fractionation of hydrocracking products; separating the exhausted coal additive and the unconverted high-boiling residue by using a solvent; supplying the mixture of the unconverted high-boiling residue and the solvent after the separation step to a vacuum column to obtain a separated heavy residue; evaporating at least part of the separated heavy residue in a thin-film evaporator to obtain a concentrated hydrocracking residue and a heavy vacuum gas oil (HVOG); and using at least a part of the HVOG to obtain the solvent. The technical result resides in ensuring the possibility of obtaining valuable products from difficult-to-utilize products, and in ensuring the stabilization of hydrocracking processes of heavy petroleum feedstock.

### TECHNICAL FIELD OF THE INVENTION

The invention relates to the field of petroleum processing, in particular a method for processing heavy petroleum feedstocks, which allows the production of valuable products from heavy residues, which are typically refractory products, which method is characterized by improved stability and efficiency, particularly in the hydrocracking processes of heavy residues derived from petroleum processing.

### BACKGROUND OF THE INVENTION

There are many known processes in the art for processing heavy hydrocarbons in the presence of special solid additives, adsorbents, and catalysts, for example, VCC, Uniflex, EST, GT-SACT, H-Oil, LC-Fining, etc. Among them, a combined hydrocracking process is the most effective process for processing heavy petroleum feedstocks, such as tar obtained after the fractional distillation of heavy Urals crude oil.

However, each of these processes is burdened with problems associated with processing residual hydrocracking products to obtain demanded and high-quality products.

For a combined hydrocracking process, document CA2157052 discloses the use of a solidified residue from liquid-phase cracking, comprising a coal additive and having passed steps of separation and subsequent vacuum distillation which is used as a binder added to coal charges for producing metallurgical coke.

However, this process, while described for residues from the processing of Arabian light crude oil, is not applicable to residues from the processing of heavy crude oils since the high content of heavy hydrocarbons and asphaltenes in these residues will inevitably lead to the coking of equipment and fail to provide necessary sintering properties.

The problem facing the present invention is the development of an effective and stable method for processing heavy petroleum feedstocks, such as heavy Urals crude oil, which makes it possible to derive valuable products from the residues formed through such processing, especially a sintering additive or bitumen products, and a stream of heavy vacuum gas oil, which can be converted into aromatic light gas oil through any known oil-refining and petrochemical process used to enhance aromatic hydrocarbon content, wherein the aromatic light gas oil can in turn be utilized in processing heavy petroleum feedstock, thereby amplifying its efficiency and diminishing its resource intensity.

### SUMMARY OF THE INVENTION

The present invention relates to a method for processing heavy petroleum feedstock, comprising:
hydrocracking a feedstock in a slurry phase (slurry phase hydrocracking (SPH)), the slurry phase comprising the heavy petroleum feedstock and a coal additive, followed by separation into a stream of an SPH-subjected feedstock and a heavy residue stream, wherein the heavy residue stream is a slurry of an unconverted high-boiling residue and a exhausted coal additive;
hydrocracking the SPH-subjected feedstock in gas phase, followed by fractionation of hydrocracking products;
separating the exhausted coal additive and the unconverted high-boiling residue by using a solvent;
supplying a mixture of the unconverted high-boiling residue and the solvent after the separation step to a vacuum column to obtain a separated heavy residue;
evaporating at least part of the separated heavy residue in an evaporator to obtain a concentrated hydrocracking residue and a heavy vacuum gas oil (HVGO); and
using at least a part of the HVGO to obtain the solvent.

To obtain the solvent, HVGO can be supplied to catalytic cracking.

Preferably, HVGO is supplied to catalytic cracking in a mixture with one or more components from the group consisting of straight-run vacuum gas oil, fuel oil from a gas condensate processing unit, and hydrotreated vacuum gas oil.

In one embodiment of the invention, the catalytic cracking mixture is characterized by the following ratios, based on the weight of the mixture:
hydrotreated vacuum gas oil and/or fuel oil of 10 to 80; and
HVGO and, optionally, straight-run vacuum gas oil of 20 to 90.

In one embodiment of the invention, the at least part of the HVGO is recycled in a mixture with the separated heavy residue into the evaporator.

In one embodiment of the invention, the heavy petroleum feedstock is characterized by an initial boiling point of 510° C. and a density at 20° C. of more than 1000 kg/m³, in particular, wherein the heavy petroleum feedstock is tar.

In one embodiment of the invention, the resulting concentrated hydrocracking residue has an ash content of not more than 1.0%, preferably not more than 0.6%.

Preferably, the coal additive used in the SPH step is a carbon material consisting of two fractions of particles, wherein the average particle size of one of these fractions (coarse fraction) is larger than the average particle size of the other fraction (fine fraction), wherein the coarse and fine fractions are characterized by different volumes of mesopores.

Preferably, the mesopore volume of the fine fraction determined by the Barrett-Joyner-Halenda (BJH) method is not less than 0.07 cm³/g and not more than 0.12 cm³/g, while the BJH mesopore volume of the coarse fraction is not less than 0.12 cm³/g and not more than 0.2 cm³/g.

Preferably, the carbon material has a BET specific surface area of not less than 230 m²/g and not more than 1250 m²/g, preferably not less than 250 m²/g and not more than 900 m²/g, most preferably not less than 270 m²/g and not more than 600 m²/g.

In one embodiment of the invention, the solvent used in the step of separating the exhausted coal additive and the unconverted high-boiling residue is an aromatic light gas oil from catalytic cracking and comprises at least 80 wt. % of aromatic hydrocarbons having C8-C16 carbon atoms.

Preferably, the evaporation takes place in a double jacket thin-film evaporator heated by flue gases.

Preferably, the separated heavy residue is fed to the thin-film evaporator through a manifold comprising discrete feed points.

Preferably, the evaporation is carried out from a film with a constant thickness, wherein the film thickness is not more than 1.5 mm, preferably not more than 1.3 mm, even more preferably the thickness is in the range of 1.1 to 1.2 mm.

Preferably, stream intermediate redistributors are provided, which are circle-shaped metal plates installed along the height of the thin-film evaporator.

Preferably, the circulation of a bottom product in the thin-film evaporator is provided by tangential introduction.

The evaporation process can be conducted under atmospheric oxygen supply to intensify the process.

Preferably, the process of evaporation from the constant-thickness film is carried out for a specified time at a temperature and an evaporation pressure which ensure a product with a mass fraction of volatile components in the concentrated hydrocracking residue of not more than 60% and a ring-and-ball softening point of the concentrated residue of at least 105° C.

HVGO can be produced by condensing vapors from the thin-film evaporator using a refrigerator, followed by collection of a distillate.

In one aspect, the claimed invention relates to a concentrated hydrocracking residue produced by the method of the present invention, characterized by an ash content of not more than 1.0%, preferably not more than 0.6%, and a ring-and-ball softening point of not less than 105° C.

In another aspect of the invention, the use of the specified concentrated residue is provided as a sintering additive in a charge for preparing various forms of coke, including metallurgical coke, foundry coke, molded coke, or for producing carbon-based products, industrial items, carbon electrodes, including anodes and cathodes in galvanic processes in the production of aluminum, and self-sintering electrodes.

According to yet another aspect of the invention, the use of said concentrated residue is provided for the production of petroleum coke, anode coke.

### BRIEF DESCRIPTION OF THE DRAWINGS

FIG. 1. Flow diagram of the claimed method.

FIG. 2. Cross-sectional view of the thin-film evaporator casing.

FIG. 3. General view of the feedstock distributor of the thin-film evaporator.

FIG. 4. General view of the rotor with installed scrapers in the thin-film evaporator.

FIG. 5. Illustration of a feedstock redistributor.

### DETAILED DESCRIPTION OF THE INVENTION

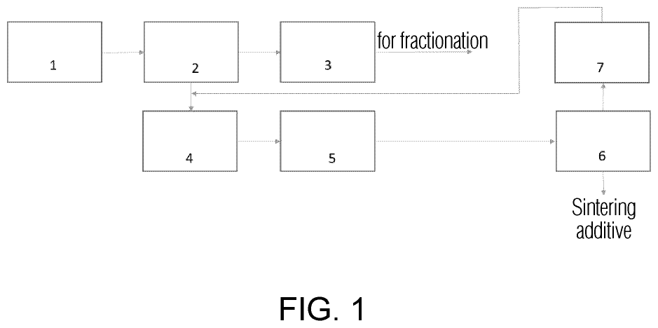

FIG. 1 shows a flow diagram of the method for processing heavy petroleum feedstock according to the present invention.

A slurry of heavy petroleum feedstock and a coal additive, which is typically added in an amount of 1 to 2% by weight based on the heavy petroleum feedstock, are fed into a slurry-phase hydrocracking (SPH) reactor to SPH step 1. Special cases of heavy petroleum feedstocks include tar, atmospheric tower (atmospheric column) bottoms, vacuum tower (vacuum column) bottoms, heavy recycle gas oil, shale oils, liquid fuels from coal, crude oil bottoms, reduced cruds and heavy bituminous crudes derived from oil sands.

An exemplary SPH process is the process described in the RU U.S. Pat. No. 2,707,294.

A hydrogen-containing gas, in particular hydrogen is used in SPH step 1, which is supplied to a pre-formed slurry of heavy oil tar, in particular tar, and a coal additive used for the adsorption of heavy hydrocarbons, such as asphaltenes. The additive comprises a porous carbon material of two different granulometric compositions-a coarse fraction and a fine fraction, wherein the particle diameter of the fine fraction is 0.063 to 0.4 mm, and the particle diameter of the coarse fraction is 0.4 to 1.2 mm. The SPH process can be carried out in one or more reactors. The additive amount depends on the reactor productivity and the number of reactors at the first SPH step—the lower the productivity and the smaller the number and volume of reactors, the smaller size of the additive. Carbon materials that can be used to produce coal additives for combined hydrocracking are known in the art. They include, for example, lignite, activated brown coal, activated coal, in particular anthracite.

In SPH step 1, hydrocarbons are decomposed and saturated in a hydrogen environment, while asphaltenes, as well as metals such as Ni, V, Fe, etc., which are catalytic poisons for gas-phase hydrocracking, are adsorbed on the coal additive.

About 95% of hydrocarbons are converted into a gaseous partially hydrogenated mixture of hydrocarbons, which are lighter components of liquid-phase hydrocracking products, such as H₂S, NH₃, H₂O, C₁, C₂, C₃, C₄, C₅ hydrocarbons, naphtha, diesel fraction, and vacuum gas oil.

Remaining approximately 5% of the substances is a slurry consisting of the said coal additive with adsorbed asphaltenes and metals, and an unconverted high-boiling residue, which is a mixture of predominantly high-boiling hydrocarbons with an initial boiling point higher than 525° C. For the purposes of this patent, the coal additive from step 1, after adsorption of asphaltenes and metals, will be referred to as a exhausted coal additive.

The products obtained in step 1 (SPH) are separated in separation step 2 into gaseous products and a slurry of an unconverted high-boiling residue and a exhausted coal additive. The separation section is located between the SPH section and gas-phase hydrocracking section.

Gaseous products are supplied to step 3 of gas phase hydrocracking, followed by fractionation of the resulting product stream to obtain light oil products.

The slurry of the unconverted high-boiling residue and the exhausted coal additive is supplied into a washing section to separation step 4.

Preferably, the additive is characterized by a sufficiently high volume, namely more than 25% of the total pore volume, of mesopores, i.e. pores with a pore size exceeding 10 nm, to achieve a more efficient adsorption of asphaltenes. Such pores allow large molecules of heavy hydrocarbons to enter and be deposited on the pore surface.

A developed specific surface area (at least 230 m²/g), especially when provided by a large number of mesopores, further contributes to an extensive “liquid-solid” phase boundary where cracking reactions occur, and a more developed surface facilitates the entry of asphaltenes into the pores minimizing the risk of them “escaping” due to the complex pore geometry, i.e., they act as a kind of pore “lock” for asphaltenes.

However, not all asphaltenes of the feedstock, including carbenes and carboids formed from secondary condensation/polymerization reactions during hydrocracking, are adsorbed by the coal additive. Approximately 10 wt. % of these substances remain as a dispersed phase surrounded by a dispersion medium, which leads to an imbalance between asphaltenes and, on the one hand, aromatic hydrocarbons that disperse asphaltenes and, on the other hand, saturated hydrocarbons that contribute to the precipitation of asphaltenes. Consequently, this unconverted high-boiling residue becomes aggregatively unstable, resulting in its segregation and the formation of challenging deposits in the form of asphaltene sediment. These deposits adversely impact the equipment operation, causing wear, shutdowns, and complications in cleaning and replacing equipment susceptible to such deposits.

In this regard, it would be desirable to increase the content of aromatic hydrocarbons in the dispersion medium, thereby preventing the precipitation of those asphaltenes which were not adsorbed by the additive.

In addition, the unconverted high-boiling residue is a fairly viscous liquid, and its flow supplied to further processing can entrain the exhausted coal additive together with asphaltenes and metals adsorbed thereon. Therefore, it is necessary to effectively reduce the viscosity of the unconverted high-boiling residue in order to separate the exhausted coal additive from it. Effective reduction of viscosity means herein the creation of a viscosity and density gradient between the unconverted residue and the exhausted coal additive so that the created gradient facilitates the separation of the exhausted additive. Considering these factors, an aromatic solvent free of paraffins, which are natural precipitants of asphaltenes, is suitable to reduce the viscosity, while preventing segregation.

The process of separating the exhausted coal additive from the unconverted high-boiling residue is carried out in separation step 4, in which the additive is washed with a solvent in the washing section.

Preferably, the washing section is a paired section consisting of a mixing tank and a separation tank. The number of paired sections can vary depending on a desired productivity and a required efficiency of the exhausted additive separation. In the mixing tank, the suspension of the coal additive and the unconverted high-boiling residue are mixed with a solvent.

The separation of the exhausted additive from the unconverted high-boiling residue occurs in a mixture with the solvent and a part of the unconverted high-boiling residue in the separation tank equipped, for example, with a cyclone unit, a decanter, or a flotation apparatus; the separation is carried out, for example, utilizing centrifugal forces, gravitational forces, or flotation.

Suitable solvents for the section of washing the exhausted coal additive may include heavy reformate, heavy gas oil from catalytic cracking, and toluene.

Preferably, in the present invention, more efficient separation of the exhausted additive is provided by using an aromatic light gas oil from petroleum processing and petrochemical process aimed at increasing the aromatic hydrocarbon content, especially through catalytic cracking, by rising the content of aromatic C8-C16 hydrocarbons to more than 80 wt. %.

Such a solvent allows an effective reduction of the viscosity of the unconverted high-boiling residue and elimination of asphaltene precipitation since it increases the fraction of aromatic compounds in the disperse system and lacks paraffins, which are natural precipitants of asphaltenes. Thus, the hydrocarbon type content provided in an aromatic light gas oil, comprising more than 80 wt. % aromatic hydrocarbons, provides better separation of the coal additive from the unconverted high-boiling residue.

This provides an additional advantage in that if a product obtained from said residue purified from the exhausted coal additive is used as a sintering additive for carbon products, the ash content of such a sintering additive will be significantly reduced.

Light aromatic gas oil from petroleum processing is usually used to produce diesel fuels and, therefore, it is impractical and unprofitable to use it as a solvent. Consequently, to provide additional light aromatic gas oil, this invention proposes using heavy vacuum gas oil produced by the method of the present invention, as described below. Utilizing this additional amount as a solvent in the separation step not only enhances the efficiency but also diminishes the resource intensity of the method. Therefore, the present invention provides an additional source of feedstock for light aromatic gas oil production, at least part of which is advantageously used as a solvent according to the present invention. The subsequent description of the method will elucidate the features of providing this feedstock source.

It should be noted that as the coal additive more efficiently adsorbs asphaltenes, fewer asphaltenes remain in the unconverted high-boiling residue, thus reducing the need for aromatic solvent in step 4 of separating the exhausted coal additive from the unconverted high-boiling residue. Furthermore, enhanced separation of the exhausted additive from the unconverted high-boiling residue in separation step 4 contributes to greater stability of the unconverted high-boiling residue in the oil dispersed system.

After the washing section, the exhausted coal additive is extracted from the process, and the separated unconverted high-boiling residue in a mixture with solvent proceeds to step 5 into a vacuum column, where, among other processes, the solvent is extracted from the separated unconverted high-boiling residue.

The products obtained from the vacuum distillation process are:
the solvent separated during vacuum distillation;
a light vacuum gas oil (LVGO) and a vacuum purified gas oil (VPGO) and
a separated heavy residue, which is a of tar-hydrocracking residual product (THRP).

The composition of the resulting THRP is homogeneous, viscous, low-ash, with a fairly low sulfur content due to having undergone the hydrocracking step and is benzpyrene-free (unlike coal tar pitch), which is important for the environment. This combination of properties became possible due to several factors:
1. utilizing the residual product after distillation of a petroleum feedstock for the process of combined hydrocracking in a hydrogen environment, which lowers sulfur levels and avoids benzopyrene in the products of the process, particularly in the residual products;
2. employing a coal additive with a high content of mesopores, which effectively adsorbs asphaltenes of the feedstock; and
3. applying a solvent in the additive washing section to ensure optimal removal of the exhausted additive from the unconverted high-boiling hydrocracking residue, which is then fed to a thin-film evaporator after the vacuum column. Such effective removal of exhausted additives from hydrocracking residues can significantly lower the ash content in a concentrated hydrocracking residue.

The inventors hypothesized that the resulting residue has properties and composition which facilitate its use as a feedstock for preparing a sintering additive used in the production of metallurgical or foundry coke or electrode mass in the manufacture of carbon anodes, for example for the aluminum industry. This hypothesis has been validated through extensive experimentation.

Furthermore, the concentrated residue can be used to prepare petroleum coke or anode coke, such as in a delayed coking unit.

Preferably, the residue is concentrated in evaporators. It is known from the prior art that devices used for concentration of highly viscous media are, for example, devices with natural circulation or devices in which the evaporation process is carried out from the film.

The best results were obtained using thin-film evaporators.

The specified bottom residue (a separated heavy residue) is directed to evaporation step 6 in a thin-film evaporator (TFE) for concentration.

In this case, an important point for the quality of the sintering additive and distillate is the prevention of local overheating of the TFE, which leads to local coking of the film with a risk of the formation of larger volumes of coke deposits inside the apparatus. In the sintering additive, such coking-susceptible inclusions diminish sintering properties as a solid carbon fraction remains in the coked material, which loses its sintering properties and acts as ballast in the composition of the sintering additive.

Based on numerous tests, devices in which the process takes place in a film formed on the inner surface of a stationary casing by a rotating rotor are deemed most efficient for producing sintering additives.

The main elements of these devices are a casing with a coaxially installed rotor and a distribution device. The film is created on the vertical surface of the casing by using a rotor with distribution scrapers mounted thereon.

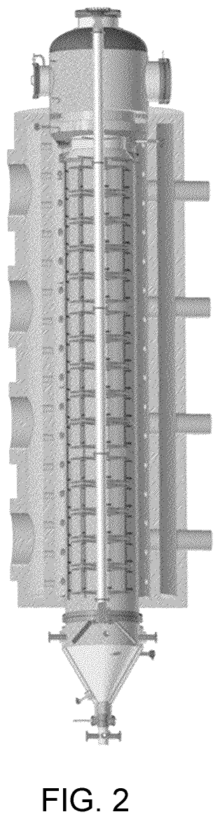

To prevent the specified unfavorable effect, namely the formation of local coking, the design was improved as follows. The TFE was equipped with a double jacket heated by flue gases fed into the outer jacket and then distributed into the inner jacket. As depicted in FIG. 2, this dual-jacket configuration ensures an even distribution of flue gases across the reactor vessel's outer surface and avoid local overheating.

All other things being equal, the higher the heating temperature of the raw material, the better the quality of the sintering additive is in terms of “ring and ball softening temperature (R&B)”, but the lower its yield becomes. The maximum temperature in the chamber is constrained by the potential for coke formation and the residence time of the mixture in the evaporator. The temperature is optimally maintained between 40° and 450° C.

The vacuum in the system can significantly reduce the temperature at which light hydrocarbons begin to evaporate, consequently diminishing the risk of coking in the released heavy residue. A reduction in the pressure facilitates a decrease in the volatile component content in the sintering additive, owing to enhanced evaporation conditions for intermediate products (or resins of secondary origin). The pressure is preferably set between minus 90 and minus 100 kPa.

The residence time of the feedstock in the apparatus is calculated based on the condition required to obtain a product with a residual mass fraction of volatile components of not more than 60%, and preferably ranges between 20 to 30 seconds.

It is desirable that the process be carried out from a film with a thickness not more than 1.5 mm, most preferably not more than 1.2 mm, and in the range of 1.1 to 1.15. Evaporation of a substance from a thin film of this specified thickness on the evaporator surface ensures high rates of heat and mass transfer. Moreover, the film thickness directly influences the quality of the resulting sintering additive, specifically, a lower quantity of volatile substances and enhanced sintering ability. Additionally, the film with a specified thickness according to the claimed method reduces the risk of coking. With a greater film thickness, there is a risk of coking on the walls, and the scrapers may not cope, causing the rotor to jam. If the thickness is less than specified, the evaporation becomes excessively intense, preventing adequate drainage of the residue and leading to local build-ups, which in turn result in coking.

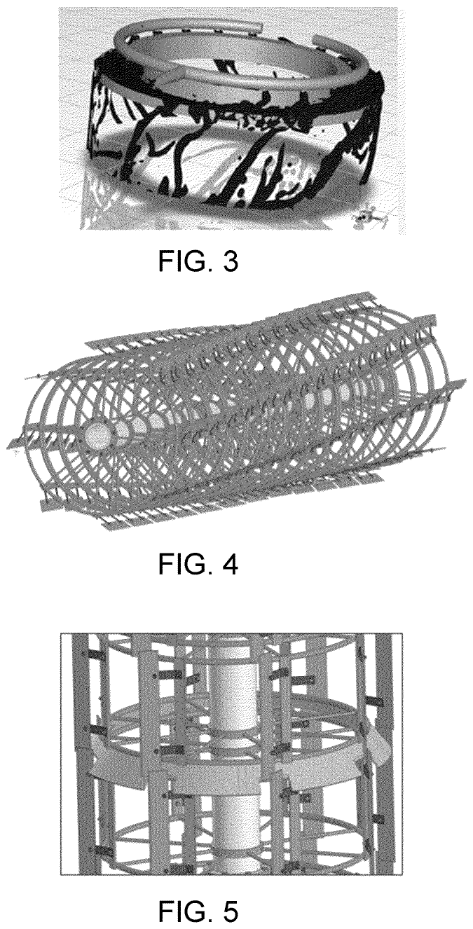

The feedstock (the stream of the separated heavy residue from the vacuum distillation column) is fed to the top of the reactor by a distribution device as shown in FIG. 3, through discrete feed points evenly spaced along the diameter of the distribution device. This input ensures additional prevention of the equipment from coking over time and the elimination of coking inclusions in the resulting sintering additive.

Uniform distribution of the feedstock along the height of the apparatus is ensured by the working elements (blades) of the rotor, distributed along the height of the rotor in the form of a spiral fragment, as shown in FIG. 4.

Stream redistributors are provided along the height of the apparatus, which are circle-shaped metal plates installed along the height of the reactor. The plates have grooves for scrapers. Their purpose is to ensure uniform application of the feedstock stream to the walls along the height of the reactor, thereby preventing stagnant zones. This arrangement is shown in FIG. 5.

The process may be intensified by supplying atmospheric oxygen to the lower part of the TFE at a rate of 40-50 L/hour, preferably 44-47 L/hour, even more preferably 45 L/hour, depending on the feedstock composition, as well as necessary requirements for the quality of the sintering additive. In this case, the process temperature can be reduced to 210-240° C.

The tar-hydrocracking concentrated residue (THCR) is extracted from the TFE bottom. In some embodiments, constant circulation of the THCR in the TFE bottom is achieved by its tangential introduction into the lower part of the TFE.

The TFE upper product, distillate vapor, is extracted from the reactor and condensed in a refrigerator. The condensed distillate is a heavy vacuum gas oil (HVGO), at least part of which is taken to processing step 7 to increase the content of aromatic hydrocarbons, in particular catalytic cracking, to produce a solvent for the additive washing section.

At least part of the HVGO is supplied to catalytic cracking in a mixture with one or more components of straight-run vacuum gas oil, hydrotreated vacuum gas oil from a combined hydrocracking unit, and fuel oil. The ratio between these four feed streams of a catalytic cracking unit can vary within wide ranges, wt. %:
Hydrotreated feedstock (hydrotreated vacuum gas oil from a combined hydrocracking unit and/or fuel oil from a gas condensate processing unit) of 10 to 80; and
Non-hydrotreated feedstock (HVGO and, optionally, straight-run vacuum gas oil) of 20 to 90.

It is important to recognize that an increase in the non-hydrotreated feedstock fraction leads to a higher yield of light gas oil from catalytic cracking. However, to prolong the catalyst life, it is advisable to dilute the non-hydrotreated feedstock with the hydrotreated one. In addition, the non-hydrotreated feedstock fraction should not be increased, as this could adversely affect the quality of the main product—the catalysate, which is then used in the production of motor gasoline.

In the case of using fuel oil, it is important to note that straight-run fuel oil obtained by distillation from petroleum cannot be used for catalytic cracking in the classical sense. For catalytic cracking, fuel oil obtained from a gas condensate processing unit (GCPU) is used since in this case its properties are similar to vacuum gas oil obtained by distillation from petroleum, i.e. the GCPU fuel oil lacks heavy fractions (tar).

The TFE bottom product is a concentrated hydrocracking residue that can be used as a sintering additive for producing metallurgical coke.

The concentrated residue may undergo additional processing, for example, in a delayed coking unit, to yield petroleum coke or anode coke.

The implemented modifications in the combined hydrocracking process enable stable, non-stop operation of the combined hydrocracking unit, leading to the production of enhanced-quality products. These modifications facilitate a consistent conversion rate of up to 95%, while also effectively addressing the challenges associated with processing of residual hydrocracking products into marketable commodities.

In the context of the present invention, the stability of operation of a combined hydrocracking unit means continuous operation in established modes with a given productivity.

### EXAMPLE

Heavy petroleum feedstock, which was tar obtained after distillation of lower-boiling fractions from heavy Urals crude oil and had an initial boiling point of 510° C. and a density at 20° C. of more than 1000 kg/m³, was mixed with 1.5 wt. % (based on mass of tar) of coal additives of two granulometric compositions: coarse fraction with a particle diameter of about 1 mm and a fine fraction with a particle diameter of about 0.3 mm. The coarse and fine fractions were characterized by different mesopore volumes: the BJH mesopore volume of the fine fraction was at least 0.07 cm³/g, and the BJH mesopore volume of the coarse fraction was at least 0.12 cm³/g for more efficient adsorption of asphaltenes with a molecule size of 40 to 90 nm for tar from Urals crude oil. The coal additive had a BET specific surface area of not less than 230 m²/g and not more than 1230 m²/g.

The feedstock in the form of slurry was supplied to SPH, where hydrogen was supplied at a temperature of 430-470° C. and a pressure of 18 to 22 MPa. A mixture of the coal additive, tar and gas passed through three SPH reactors. The resulting mixture was produced consisting of gaseous products and slurry comprising an exhausted coal additive and an unconverted high-boiling residue. This mixture was supplied to the separation step, after which a gaseous stream was supplied to gas-phase hydrocracking, and the slurry was supplied to the additive washing section consisting of a mixing tank and a cyclone separation tank.

The slurry of the unconverted high-boiling residue together with the solid exhausted additive at a flow rate of 15-20 tons/h, a temperature of about 420° C., and a pressure of not more than 0.3 MPa was mixed with an aromatic light gas oil from catalytic cracking at a flow rate of 30-35 tons/h, a temperature of about 220-260° C. in a mixing tank. The pressure in the mixing tank was excess by 0.15 to 0.35 MPa and was regulated by a system of control valves to avoid excessive evaporation of the solvent.

Then the stream was fed into a separation tank equipped with a cyclone unit, where the exhausted additive was separated from the unconverted high-boiling residue mixed with aromatic light gas oil from catalytic cracking by means of centrifugal forces.

After the washing section, the exhausted coal additive was extracted from the process, and the separated unconverted high-boiling residue heated to a temperature of not more than 385° C. and mixed with aromatic light gas oil from catalytic cracking was supplied to a vacuum column. At the top of the vacuum column, the vacuum was 10 to 150 mmHg, preferably 40 to 70 mmHg, even more preferably 10 to 30 mmHg, with a pressure difference between the bottom part of the vacuum column and the lower layer of a packing, including a “blind” plate, of not more than 15 mmHg, and the temperature of the vacuum column bottom was not more than 305° C.

The products obtained from the vacuum distillation process were:
light vacuum gas oil (LVGO) and vacuum purified gas oil (VPGO); and
separated heavy residue, which was a tar-hydrocracking residual product (THRP).

The heavy residue (bottom residue) obtained by the above method had the following physical and mechanical properties:

TABLE 1

| | | |
|---|---|---|
| 1 | Density at 15° C., kg/m³ | 1.054 |
| 3 | Flash point in open cup, ° C. | 195 |
| 4 | Mass fraction of sulfur, % by weight | 1.945 |
| 5 | Coking capacity, % by weight | 21.21 |
| 6 | Dynamic viscosity, cPa | |
| | at 200° C. | 221 |
| | at 240° C. | 45 |
| 7 | Fractional composition, % by weight | |
| | Initial boiling point, ° C. | 340 |
| | 130-180° C. Fraction | |
| | 180-200° C. Fraction | |
| | 200-340° C. Fraction | |
| | 340-460° C. Fraction | 22.98 |
| | Residue, more than 460° C. | 77.02 |
| | 460-480° C. Fraction | 7.60 |
| | 480-500° C. Fraction | 7.60 |
| | 500-540° C. Fraction | 14.80 |
| | Residue, more than 540° C. | 47.02 |
| 8 | Asphaltenes, % by weight | 20.69 |
| 9 | Carbenes, % by weight | 1.01 |
| 10 | Carboids, % by weight | 2.27 |
| 11 | Setting point, ° C. | plus 30 |

The above bottom residue (the separated heavy residue) was fed through a manifold comprising discrete feed points to a thin-film evaporator (TFE) for concentration.

The temperature in the reactor was maintained at 400° C. The pressure in the reactor was maintained at minus 95 kPa.

The film thickness was 1.12 mm and was constant along the height of the apparatus.

The residence time of the feedstock in the apparatus for the above-mentioned bottom residue and the specified film thickness was 20 seconds.

The distillate obtained by the method of the present invention had the following characteristics:

TABLE 2

| | | | Test |
|---|---|---|---|
| | | | results |
| | | | (average |
| No. | Parameter | Test method | data) |
| 1 | Density at 20° C., kg/cm³ | GOST 3900 | 982.1 |
| 2 | Mass fraction of sulfur, % | GOST P 51947 | 1.93 |
| 3 | Coking capacity, % by weight | EN ISO 10370 | 1.55 |
| 4 | Fractional composition: | | |
| | initial boiling point, ° C. | ASTM D 86 | 302 |
| | distilled at 400° C., % | | 37 |
| 5 | Kinematic viscosity at 50° C., mm²/s | TOCT 33 | 56.12 |
| 6 | Setting temperature, ° C. | GOST 20287 | 23.4 |
| | | (Method B) | |
| 7 | Flash point in closed cup, ° C. | ASTM D 93 | 175.4 |
| 8 | Asphaltenes content, mg/kg | Total 642 | 710.6 |
| 9 | Metal content | | |
| | Sodium, mg/kg | ASTM D 5863 | 1.02 |
| | Iron, mg/kg | | 20.32 |
| | Nickel, mg/kg | | 2.51 |
| | Vanadium, mg/kg | | 1.05 |

The concentrated tar-hydrocracking residue produced by the proposed method had the characteristics given in Table 3:

TABLE 3

| | Unit of | | Document for test |
|---|---|---|---|
| Determined parameters | meas. | Test results | method |
| Ash content, dry state, A^{d} | % | 0.6 | GOST 22692-77 |
| Mass fraction of volatile substances, dry | % | 52.4 | GOST 22898-78 |
| state, V^{d} | | | |
| Mass fraction of total sulfur, dry state, Sₜ^{d} | % | 2.23 | GOST 32465-2013 |
| Mass fraction of total carbon, dry state, C^{d} | % | 87.3 | GOST 32979-2014 |
| Mass fraction of water, W | % | 0.1 | GOST 2477-2014 |
| Mass fraction of insoluble substances in | % | 25 | GOST 7847-2020 |
| toluene, α | | | |
| Mass fraction of substances insoluble in | % | 5 | GOST 10200-2017 |
| quinoline, α₁ | | | |
| Ring&Bar Softening point (melting point), | ° C. | 113 | GOST 9950-2020 |
| T | | | |
| R&B Softening point (melting point), T | ° C. | 128 | GOST 11506-1973 |
| Softening (melting) temperature according | ° C. | 131 | GOST 32276-2013 |
| to Mettler, T | | | |
| Gray-King coke type | type | G₁₃ | GOST 16126-91 |
| | | | (ISO502-82) |
| Coking index, G (1:5) | unit | 80 | GOST ISO 15585- |
| | | | 2013 |
| Coking index, G (1:7) | unit | 68 | GOST ISO 15585- |
| | | | 2013 |

These parameters make it possible to use THCR as a sintering additive to produce metallurgical coke, foundry coke, or anodes for the aluminum industry, which have excellent sintering properties similar to the sintering properties of coal-tar pitches.

As a result of industrial tests of the claimed method, the achieved productivity of feedstock, in particular tar, was at least 2,600,000 tons per year.

1. A method for processing a heavy petroleum feedstock, comprising:
hydrocracking a feedstock in a slurry phase (slurry phase hydrocracking, SPH), the slurry phase comprising the heavy petroleum feedstock and a coal additive, followed by separation into a stream of an SPH-subjected feedstock and a heavy residue stream, wherein the heavy residue stream is a slurry of an unconverted high-boiling residue and an exhausted coal additive;
hydrocracking the SPH-subjected feedstock in gas phase, followed by fractionation of hydrocracking products;
separating the exhausted coal additive and the unconverted high-boiling residue by using a solvent;
supplying a mixture of the unconverted high-boiling residue and the solvent after the separation step to a vacuum column to obtain a separated heavy residue;
evaporation of at least part of the separated heavy residue in an evaporator to obtain a concentrated hydrocracking residue and a heavy vacuum gas oil (HVGO); and
using at least a part of the HVGO to obtain the solvent.

2. The method according to claim 1, wherein the at least part of the HVGO is subjected to catalytic cracking to produce the solvent, preferably wherein the HVGO is supplied to catalytic cracking in a mixture with at least one of the following components: straight-run vacuum gas oil, fuel oil, in particular a fuel oil from a gas condensate processing unit, and hydrotreated vacuum gas oil.

3. The method according to claim 2, wherein the mixture for catalytic cracking is characterized by the following ratios, based on the weight of the mixture:
hydrotreated vacuum gas oil and/or fuel oil of 10 to 80; and
HVGO and optionally straight-run vacuum gas oil of 20 to 90.

4. The method according to claim 1, wherein at least part of the HVGO is supplied to recycling in a mixture with the separated heavy residue into the evaporator.

5. The method according to claim 1, wherein the heavy petroleum feedstock is characterized by an initial boiling point of 510° C. and a density at 20° C. of more than 1000 kg/m³, and in particular wherein the heavy petroleum feedstock is tar.

6. The method according to claim 1, wherein the coal additive used in the SPH step is a carbon material consisting of two fractions of particles, wherein the average particle size of a coarse fraction is larger than the average particle size of a fine fraction, and wherein the coarse and fine fractions are characterized by different volumes of mesopores.

7. The method according to claim 6, wherein the mesopore volume of the fine fraction determined by the Barrett-Joyner-Halenda (BJH) method is not less than 0.07 cm³/g and not more than 0.12 cm³/g, while the BJH mesopore volume of the large fraction is not less than 0.12 cm³/g and not more than 0.2 cm³/g.

8. The method according to claim 6, wherein the carbon material has a BET specific surface area of not less than 230 m²/g and not more than 1250 m²/g, preferably not less than 250 m²/g and not more than 900 m²/g, most preferably not less than 270 m²/g and not more than 600 m²/g.

9. The method according to claim 1, wherein the solvent is an aromatic light gas oil from catalytic cracking, comprising at least 80 wt. % of aromatic hydrocarbons having C8-C16 carbon atoms.

10. The method according to claim 1, wherein the evaporation takes place in the evaporator, which is a thin-film evaporator, in particular wherein the thin-film evaporator has a double jacket heated by flue gases.

11. The method of claim 10, wherein the separated heavy residue is fed to the thin-film evaporator through a manifold comprising discrete feed points.

12. The method according to claim 10, wherein the evaporation is carried out from a film with a constant thickness, wherein the film thickness is not more than 1.5 mm, preferably not more than 1.3 mm, even more preferably the thickness is in the range of 1.1 to 1.2.

13. The method according to claim 10, wherein intermediate stream redistributors are provided along the height of the thin-film evaporator, which are circle-shaped metal plates installed along the height of the reactor.

14. The method of claim 10, wherein the thin-film evaporator comprises a bottom part configured to circulate a bottom product of the thin-film evaporator by tangentially introducing the bottom product into the bottom part of the thin-film evaporator.

15. The method according to claim 1, wherein the evaporation process is conducted under air oxygen supply.

16. The method according to claim 1, wherein the process of evaporation from the constant-thickness film is carried out for a specified time at a temperature and pressure which ensure the evaporation of volatile components to a mass fraction of volatile components in the concentrated residue of not more than 60% and a ring-and-ball softening point of the concentrated residue of not less than 105° C.

17. The method according to claim 1, wherein the HVGO is obtained by condensing vapors from the thin-film evaporator using a refrigerator, followed by collection of a distillate thus obtained.

18. A concentrated hydrocracking residue used as a sintering additive for carbon products, obtained by the method according to claim 1, characterized by an ash content of not more than 1.0% and a ring-and-ball softening point of not less than 105° C.

19. Use of the concentrated residue according to claim 18 as a sintering additive to a charge for the preparation of coke, more specifically metallurgical coke, foundry coke, in particular molded coke; or for the preparation of petroleum coke or anode coke.

20. Use of the concentrated residue according to claim 18 as a sintering additive to a charge for the production of carbon electrodes, such as an anode or cathode for galvanic processes, in particular for the production of aluminum, or for the preparation of self-sintering electrodes.
